(19) United States
(12) Patent Application Publication
(10) Pub. No.: US 2007/0108183 A1
(43) Pub. Date: May 17, 2007

(54) ELECTRON SOURCE FOOD TREATING APPARATUS AND METHOD

(76) Inventor: Steven Maupin, Akron, OH (US)

Correspondence Address: HAHN LOESER & PARKS, LLP, One GOJO Plaza, Suite 300, AKRON, OH, 44311-1076, US

(21) Appl. No.: 11/539,755

(22) Filed: Oct. 9, 2006

Related U.S. Application Data
(60) Provisional application No. 60/724,975, filed on Oct. 7, 2005.

(51) Int. Cl. F27D 11/00

(52) U.S. Cl. 219/438

(57) ABSTRACT

A food treating apparatus and method wherein an electric current is provided by an electric circuit; the food treating apparatus including a vessel, a conductive food-contact surface, and a battery, and wherein the electric circuit supplies a constant current and is operative to provide electrons to food in the vessel.

This application claims priority to provisional application Ser. No. 60/724,975, filed Oct. 7, 2005, the disclosure of which is hereby incorporated by reference.

### BACKGROUND

As discussed in U.S. Pat. Nos. 5,356,646, 6,528,768, and 6,828,527 to Simic-Glavaski, et al. (hereinafter “Simic-Glavaski”), ingesting oxidized products (such as foods cooked by thermal processes) may cause or incite cancer or promote cardiovascular problems. As an example, oxidation and thermal excitation causes food to lose electrons during a cooking process. Also, by way of example, cooking oil at high temperatures generates numerous oxidative products in foods that may have undesirable effects on food quality and safety, such as acrylamide.

To inhibit oxidation of food and/or cooking oil, Simic-Glavaski discloses adding electrons and/or negative ions (hereinafter collectively referred to as “electrons”) to food in a cooking vessel or in contact with a grill. By adding electrons to the cooking process, the extent of oxidation is reduced, thereby diminishing the harmful effects of oxidation, including the formation of acrylamide.

Cooking vessels disclosed by Simic-Glavaski have an anode and a cathode, and an energy source, such as an electrochemical battery or solar cell contained in a handle or a conventional battery or electrical outlet. The anode and cathode are arranged such that electric current flows between each, thereby directing electron flow through or in communication with the food. The current flow provides excess electrons that are absorbed by the food to replace electrons lost by thermally induced oxidation, avoiding electron-depleted food.

As many cooking vessels are electrically conductive, one problem in the prior art is that the cooking vessel effectively causes a short circuit between the anode and cathode. Consequently, a rapid flow of current quickly depletes the battery. Further, there is no indication of whether the battery is depleted, or whether the optimum current is flowing between the anode and cathode. Also, supplying excess current or voltage to the food reduces the effectiveness of the food treating process.

Another problem within the art is providing the necessary electrons to the food without prematurely exhausting the power source. Providing too many electrons to the food reduces the effectiveness of the treating process, while draining power unnecessarily from the power source. Providing too few electrons to the food reduces the effectiveness of the treating process, except that power is conserved. In addition, the current that supplies electrons to the food generally diminishes over the life of various power sources, such as, for example, batteries. As a battery is used, the voltage potential across the battery drops, which consequently reduces the current and the supply of electrons. Therefore, there is a need to provide a constant and more optimum supply of electrons for effectively treating food, which more efficiently uses the power source over its life.

A further problem is that there is no indication that the device is working properly. Because it is not always evident that the food treating process is working, it would be beneficial to indicate to a user that the device is working properly, i.e. whether the current flow is below an effective level, the battery is depleted, or if current is flowing between the anode and cathode.

The foregoing illustrates limitations known to exist in food treating apparatuses. Thus, it is apparent that it would be advantageous to provide an alternative directed to overcoming one or more of the limitations set forth above.

### SUMMARY OF THE INVENTION

The present invention overcomes one or more of the disadvantages of the prior art. The following description sets forth in detail certain illustrative embodiments of the invention, these being indicative of but a few of the various ways in which the principles of the present invention may be employed.

### BRIEF DESCRIPTION OF THE DRAWINGS

FIG. 1 is a side perspective view of a vessel and exploded view of one embodiment of a handle of the present invention.

FIG. 2 is a rear perspective view of a second embodiment of a handle of the present invention.

FIG. 3 is a top view of the second embodiment of a handle of the present invention.

FIG. 4 is a partial side perspective view of a vessel and exploded view of a third embodiment of a handle of the present invention.

FIG. 5 is a side perspective view of a vessel and exploded handle of a fourth embodiment of the present invention.

FIG. 6 is a side perspective view of the vessel of FIG. 5 with electrodes forming a part of the food contact surface.

FIG. 7 is a top view of a battery holder for the handle embodiment of FIGS. 1-3.

FIG. 8 is a side view of a battery holder for the handle embodiment of FIGS. 1-3.

FIG. 9 is a rear view of a battery holder for the handle embodiment of FIGS. 1-3.

FIG. 10 is a circuit diagram of the present invention.

FIG. 11 is a partial vertical cross section through a vessel of FIG. 1.

FIG. 12 is a graph indicating the rapid drop of current over time in the prior art.

FIG. 13 is a graph indicating the constant current over time from the circuit of FIG. 10 of the present invention.

FIG. 14 is a side perspective view of the handle of FIG. 1.

FIG. 15 is a top perspective view of the battery holder of FIGS. 7-9.

FIG. 16 is a top view of an alternative embodiment of a handle of the present invention.

FIG. 17 is a cross-sectional side view of the handle of FIG. 16.

FIG. 18 is an end view of the handle of FIG. 16.

FIG. 19 is an exploded perspective view of the handle of FIG. 16.

FIG. 20 is a top view of an alternative embodiment of a handle of the present invention.

FIG. 21 is a cross-sectional side view of the handle of FIG. 20.

FIG. 22 is a perspective view of the handle of FIG. 20.

FIG. 23 is an exploded view of the handle of FIG. 20.

FIG. 24 is an alternative embodiment of a circuit diagram of the present invention.

### DETAILED DESCRIPTION

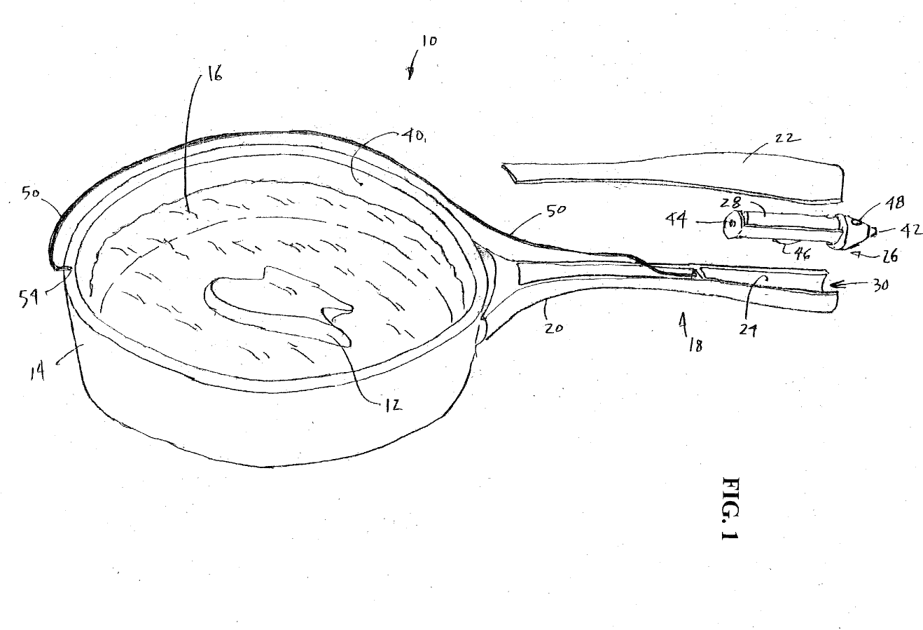

With reference to FIG. 1, a food treating apparatus 10 for providing electrons for absorption by a food material 12 is shown. The food treating apparatus 10 includes a vessel 14, a power source 28, and a circuit 36. A handle 18 may be attached to the vessel 14.

The vessel 14 has sufficient volume to contain the food material 12. The vessel 14 may be a storing container, cooling container, preparing container, warming container, serving container or any of a wide variety of food containing vessels; non-limiting examples include a pot, pan, coffeepot, carafe, cookware, grill, skillet, kettle, dish, bowl, wok, appliance or the like and associated utensils. Non-limiting examples of utensils may include a probe, a skewer, a spit or the like. The vessel 14 comprises at least one food-contact surface 40 made of any electrically conductive material, including but not limited to metal, stainless steel, copper, aluminum, electrically conductive plastic, or the like. The vessel 14 and/or food-contact surface 40 may be coated with a nonstick coating to prevent the food 12 from sticking to them, the coating facilitating or otherwise not inhibiting electrical conduction. The food material 12 may be placed in the vessel 14, alone or with a medium 16. The medium 16 may be an oxidizing medium, such as for example water, sauce, oil, fat, or any other medium used in a boiling, cooling, warming, steaming, basting, skewering, sauteing, baking, roasting, frying or deep frying process or any other cooking, storing, cooling, preparing or treating process.

The power source 28 may be a conventional battery, such as a zinc carbon, alkaline, nickel cadmium, or lithium battery, an electrochemical battery, solar cell, or an electrical outlet, adapted to provide electrons to the vessel 14. In one embodiment, power source 28 is a conventional AA-size battery. In other embodiments, power source 28 may be other conventional sizes, including but not limited to standard battery sizes AAA, C, D, or other standard or custom sizes.

The handle 18 may be made of any material that is suitable for the specific application in which apparatus 10 is used. As non-limiting examples, handle 18 may be in part or in whole formed of an electrically insulative material, an electrically conductive material, a thermally insulative material, a thermally conductive material, plastic, metal, phenolic, glass, ceramic, wood or any other material that has strength, rigidity, thermal, and electrical properties suitable for the desired purpose or use of the apparatus 10. In embodiments where the handle 18 is thermally conductive, such as metal, an insulating material such as a gasket may be provided between the cooking vessel 14 and at least a portion of the handle 18 to slow the transfer of heat to the handle 18.

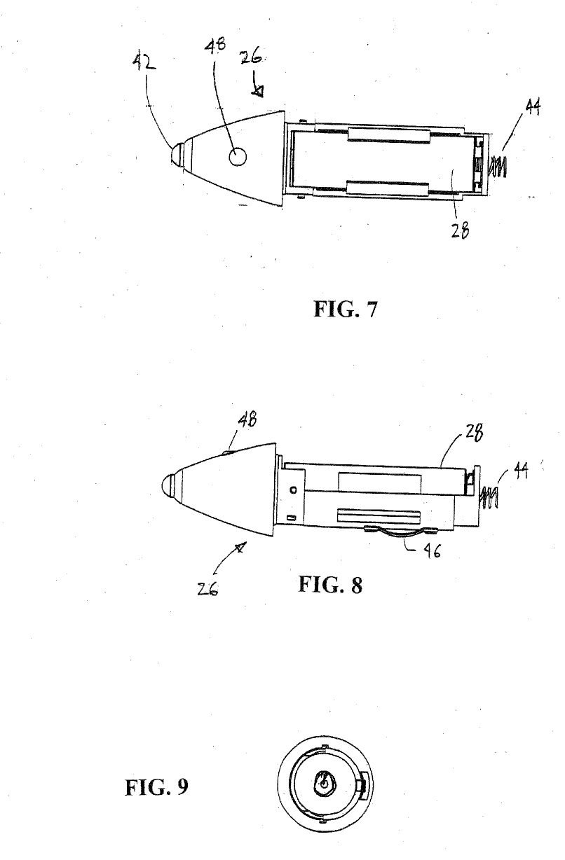

In an embodiment shown in FIG. 1, the handle 18 is adapted to house a battery holder 26 and the power source 28. The battery holder 26 of this embodiment is illustrated in FIGS. 7-9. In the embodiment of FIG. 1, a handle base 20 and a handle insert 22 define an enclosure 24 such that an aperture 30 is formed in an end of the handle 18. In this embodiment, the handle base 20 and the handle insert 22 are adapted for the battery holder 26 to enter the enclosure 24 through the aperture 30. The handle base 20 and handle insert 22 are fastened together by any suitable means known in the art. In one embodiment, the handle base 20 and handle insert 22 are welded together. In an alternate embodiment, threaded fasteners or rivets hold the handle base 20 and handle insert 22 together. In another embodiment, the handle base 20 and the handle insert 22 are formed together in one piece.

In the embodiment of FIG. 1, the battery holder 26 is removably attached such that a user can install or replace the power source 28 by removing the battery holder 26 from the handle 18. The user may wish to remove the battery holder 26 before washing or storing the food treating apparatus 10, or before placing the food treating apparatus 10 in an oven or other cooking or heating apparatus. It is contemplated that any other power source may be used in place of the power source 28 and battery holder 26.

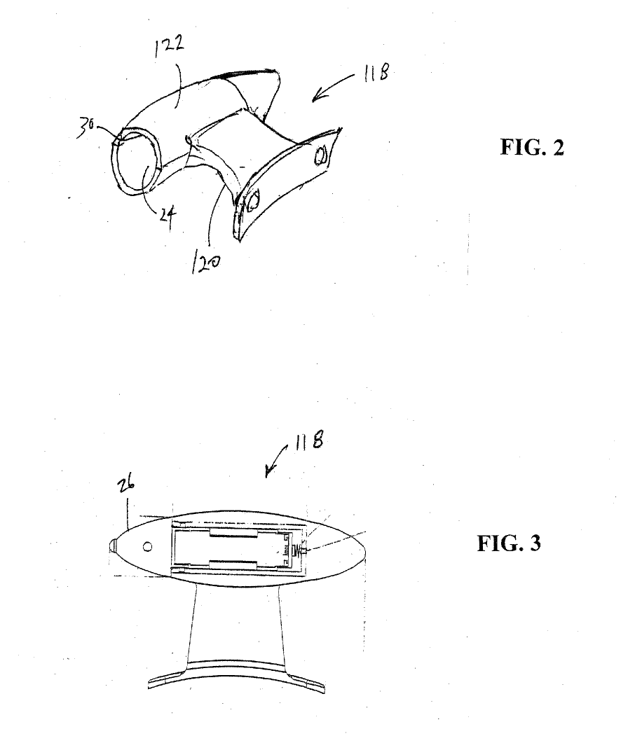

In a handle embodiment shown in FIGS. 2 and 3, a handle 118 is adapted to house the battery holder 26 and the power source 28. In this embodiment, a handle base 120 and a handle insert 122 define the enclosure 24 such that aperture 30 is formed in the handle 118. In this embodiment, the handle base 120 and the handle insert 122 are adapted for the battery holder 26 to enter the enclosure 24 through the aperture 30. The handle base 120 and handle insert 122 are fastened together by any suitable means, such as by welding, rivets, fasteners, or other means known in the art. In another embodiment, the handle base 120 and the handle insert 122 are formed together in one piece.

In the embodiment of FIG. 2, the battery holder 26 is removably attached such that a user can install or replace the power source 28 by removing the battery holder 26 from the handle 118. The user may wish to remove the battery holder 26 before washing or storing the food treating apparatus 10, or before placing the food treating apparatus 10 in an oven or other cooking or heating apparatus. It is contemplated that any other power source may be used in place of the power source 28 and battery holder 26.

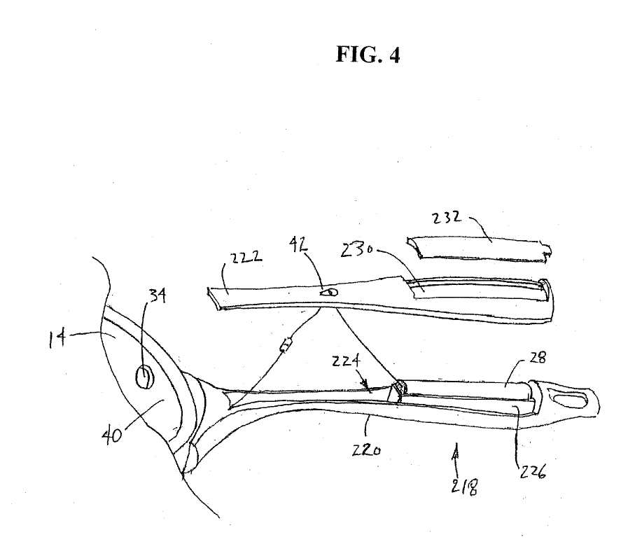

An alternate handle embodiment is shown in FIG. 4. In this embodiment, a handle 218 comprises a handle base 220 and a handle insert 222. In the embodiment of FIG. 4, the handle insert 222 includes an aperture 230, collocated over the battery holder 226 and sized to allow the power source 28, or any other power source used, to pass through. The aperture 230 allows a user to install and replace the power source. A battery cover 232 fits within aperture 230 to protect and enclose power source 28 within handle 218. In one embodiment, the handle base 220 and handle insert 222 are welded together. In an alternate embodiment, threaded fasteners or rivets hold the handle base 220 and handle insert 222 together. In another embodiment, the handle base 220 and the handle insert 222 are formed together in one piece.

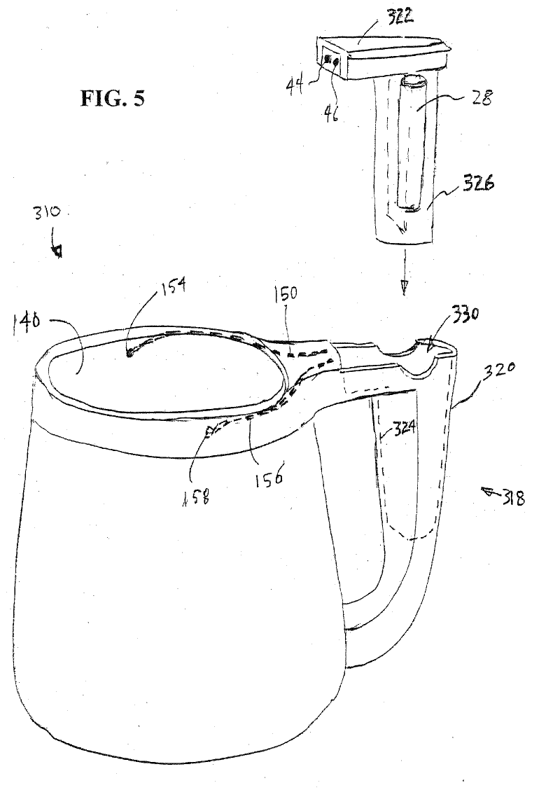

In an embodiment shown in FIG. 5, a handle 318 comprises a handle base 320 and a handle insert 322. The handle base 320 includes an enclosure 324, which is sized to house the handle insert 322. In this embodiment, the handle insert 322 houses the battery holder 326 and the power source 28. The handle base 320 and the handle insert 322 may be designed to allow the handle insert 322 to enter enclosure 324 through an aperture 330. In this embodiment, the handle insert 322 is removably attached such that a user can install or replace power source 28 by removing the handle insert 322 from the handle 318 through aperture 330. The user may also wish to remove the handle insert 322 before washing or storing the food treating apparatus 310, or before placing the food treating apparatus 310 in an oven or other cooking or heating apparatus. It is contemplated that any other power source may be used in place of the power source 28 and battery holder 326.

In any embodiment, the handle 18 may be fixedly or removably attached to the vessel 14. One or more rivets 34, or any other fastener or fastening method known in the art, may secure the handle 18 to the vessel 14. It is contemplated that some embodiments of the present invention comprise a removable handle 18 or handle portion such that a user can selectively remove the handle 18, or a portion thereof, before washing or placing the apparatus in an oven. Further, the handle 18 may be interchangeable among several different types of vessel, such that the user can remove the handle from one cooking vessel and place it on another. Other handle structures and styles are contemplated within the spirit and scope of the present invention.

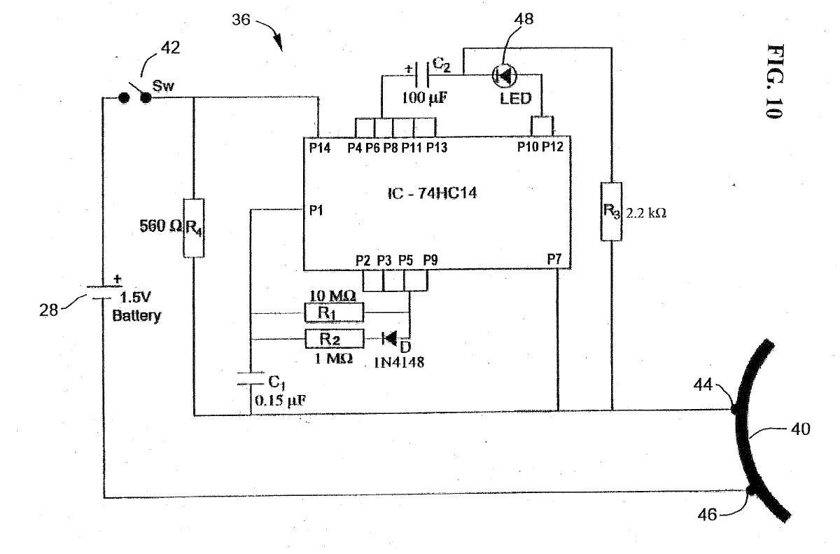

The food treating apparatus 10 includes a circuit 36, as exemplified in FIG. 10. The circuit 36 produces a current and a voltage differential whereby electrons 38 flow to the food-contact surface 40 of the vessel 14. The circuit 36 may include the power source 28, the food-contact surface 40, and/or the vessel 14. In one embodiment, the circuit 36 is generally housed within the handle 18. In another embodiment, circuit 36 is specifically positioned within the battery holder 26, 226, 326.

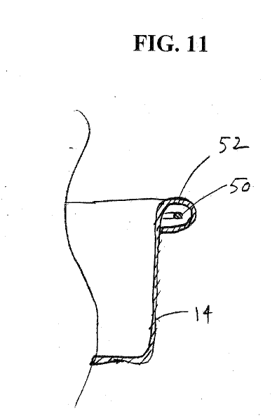

The circuit 36 further comprises electrodes 44 and 46 that connect circuit 36 to the food-contact surface 40. In one embodiment, electrodes 44 and/or 46 may be in electrical communication with vessel 14 or food-contact surface 40 through wires or other means in the art. Specifically, in the embodiment of FIG. 1, electrode 44 makes electrical contact with a wire 50 that connects to the vessel 14 while electrode 46 contacts the handle base 20. Because handle base 20 is made from an electrically conductive material. electrode 46 is in electrical communication with vessel 14. The handle 18 of FIG. 1 may partially contact the vessel 14 to provide the electrical connection. In one alternative, electrically conductive fasteners, such as rivets, may conduct electrons between the handle 18 and the vessel 14. As illustrated in FIG. 11, the top lip 52 of the vessel 14 is rolled to cover and protect wire 50. The wire end 54, which is an extension of electrode 44, is positioned approximately 180 degrees from the handle attachment, the handle being an extension of electrode 46.

In the embodiment of FIG. 5, electrodes 44 and 46 are in electrical contact with wire 150 and 156 respectively. Wire end 154, which is an extension of electrode 44, is in contact with food contact surface 140. Wire end 154 is located approximately 180 degrees from wire end 158, which is an extension of electrode 46 and is in contact with surface 140. It is contemplated that the wires 150 and 156, used to extend electrodes 44 and 46, could be adapted with any vessel 14.

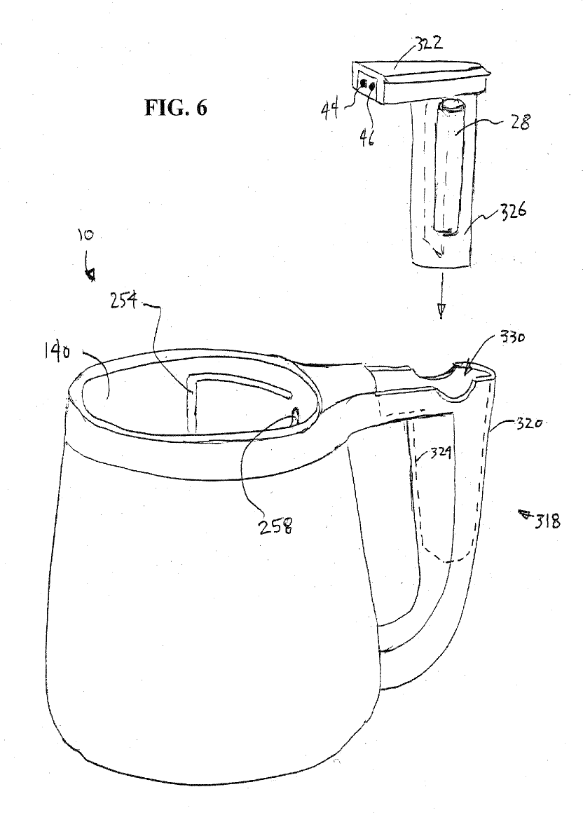

Electrode 44 and/or 46 may form part of the contact surface 40, as shown, for example, in FIG. 6. As illustrated in FIG. 6, an element 254 is in electrical communication with electrode 44, and an element 258 is in electrical communication with electrode 46. The elements 254 and 258 are made of electrically conductive material, and are adjacent to and/or form a part of the food contact surface 140.

In one embodiment, electrodes 44 and 46 may be independent rivets 34 that hold the handle 18 to the vessel 14, as shown in FIG. 4. However, the rivets that hold the handle 18 onto the vessel 14 are generally placed relatively close together. Placing the electrodes a greater distance from each other, such as on opposite sides of the vessel 14, ensures that the current traveling between the electrodes affects as much food 12 or medium 16 as possible.

Circuit 36 may be a constant-current circuit. The constant-current circuit maintains current flow through the circuit 36 at an approximately constant desired current level, while preventing excessive currents from unnecessarily depleting the power source. The circuit 36 is not limited to the circuit design illustrated in FIG. 10. One skilled in the art would recognize variations to the constant-current circuit designs embodied in FIG. 10 that are within the spirit and scope of the invention.

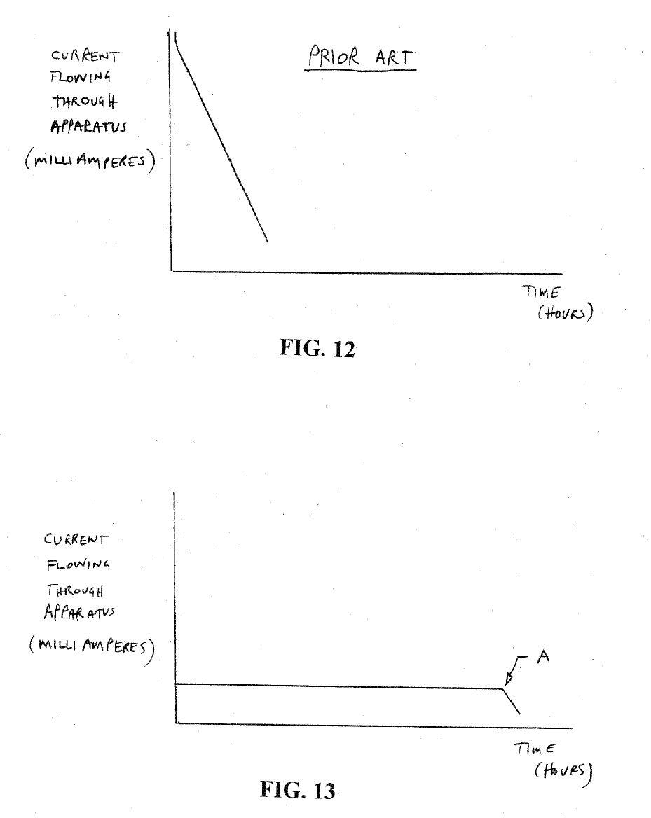

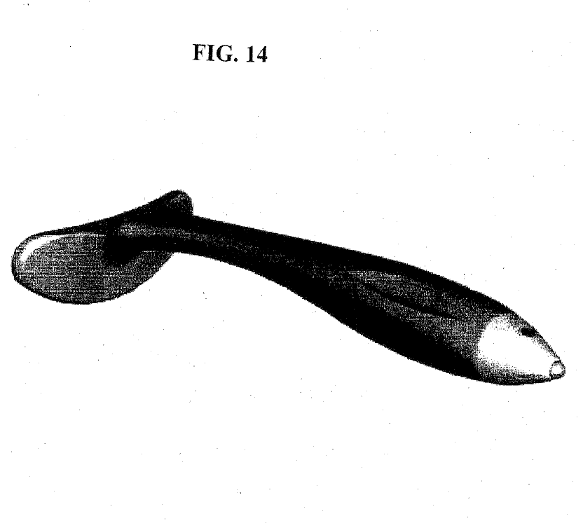

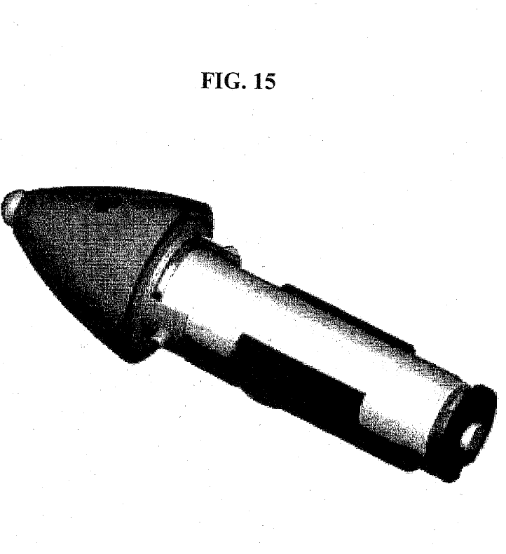

To overcome the problem of the prior art, the circuit 36 maintains an approximately constant current as indicated in FIG. 13. FIG. 12 illustrates a graph of current over time in the prior art, wherein a battery discharges through a pan or other cooking vessel to provide electrons. In the prior art, a battery rapidly discharges through a short circuit caused by the pan, causing the current flow to start out at a higher current level and drop rapidly until the battery is depleted. As indicated in FIG. 13, the circuit 36 regulates the current level to maintain a lower, specified value. When the battery is discharged at a lower constant current, the battery life is extended greatly. Further, at a constant current, the food treatment apparatus 10 delivers a consistent number of electrons over time. The desired constant current may approximately be the optimum current for treating the food 12.

When the battery voltage drops below a threshold value, as the battery becomes depleted, the battery will not be capable of providing the selected constant current level. This point is indicated on FIG. 13 as point A. When the battery reaches the threshold voltage A, the user should change the battery, as the effectiveness of the food treatment will decline.

The constant current circuit 36 is designed to operate at a specified voltage and current. The effectiveness of food treating depends on the current and the voltage. After performing a series of controlled tests, the most acceptable results occurred with voltages approximately between 1.5 to 3.0 volts, with constant current values selected from the range of approximately 2.0 to 2.7 milliamperes. The best results occurred with the combination of approximately 1.5 volts and a constant current value of approximately between 2.4 and 2.5 milliamperes. Generally, a circuit designed for a higher voltage should have a lower accompanying current than a circuit designed for a lower voltage.

Voltages and currents outside the ranges specified above may be used to treat food 12 with electrons; however, the results will not be as effective as those obtained within the above specified ranges. Some foods, such as cooking oils, exhibit a characteristic where the amount of current that flows through the food reduces as the voltage increases. In the case of some cooking oils, the food treatment is not effective at voltages higher than 3 volts. The above specified voltages and currents may be optimized depending upon the type or quantity of food 12 treated. The food quantity may require more or less electrons. Also, the resistance of the food 12 may necessitate higher or lower currents.

In some embodiments, the circuit 36 includes an indicator to show that electric current is flowing through the electric circuit. In the embodiment illustrated in FIGS. 1-4 and 10, the indicator is a light emitting diode 48 (LED). In the embodiment of FIG. 1, LED 48 is located within battery holder 26 and the light is directed using a light pipe or fiber optics. It is contemplated that the LED 48 could be placed in any suitable location on the food treating apparatus. Consequently, the light pipe or fiber optics may not be needed. The LED 48 may flash to preserve battery life, extending the battery life to approximately 2 months, or up to at least 14 months, depending upon how frequently the food treating apparatus is used. It is contemplated that other indicators may be used, such as for example, a light bulb, liquid crystal display, vibration motor, or audible alert.

The circuit 36 of the present invention may include a low-voltage shut-off circuit. The low-voltage shut-off switch functions to stop a flow of current when the voltage of the power source 28, such as a battery, drops to a threshold value. A battery's ability to supply electrons diminishes as the battery voltage drops. Thus, a new battery at its maximum voltage potential has relatively high current production (high available current), and as the battery is used up the battery's voltage gradually drops and the battery's current production gradually drops (low available current), as is indicated in FIG. 12. As the circuit 36 is designed to maintain a constant current output, the threshold shut-off voltage may be determined by selecting the battery voltage where the battery's available current is less than the constant current output, as indicated as point A on FIG. 13. By replacing the battery when the battery cannot produce the desired constant current output, the food treating apparatus will maintain its effectiveness in treating food.

The circuit 36 embodied in FIG. 10 includes a low-voltage shut-off circuit utilizing a Schmit trigger. In this embodiment, the low-voltage shut-off deactivates the ILED 48 and not the current to/from the power source 28 to signal to the user that the battery is low. In this embodiment, electrons continue to flow from the electrodes after the LED 48 deactivates, so long as the power source 28 can supply current. However, the low-voltage shut-off circuit is not limited to the design illustrated in FIG. 10. One skilled in the art would recognize various low-voltage shut-off circuit designs and features that would be consistent with the scope and spirit of the present invention.

In one embodiment, the threshold battery voltage value for the low-voltage shut-off is 0.9 volts. In other embodiments, threshold values may fall within a range of 0.5-1.4 volts, depending upon the specification of power source 28 and the desired electron flow. It is contemplated that other threshold values will be used depending upon the specification of power source 28 and the desired electron flow.

As represented in FIGS. 1 and 4, the circuit 36 may include a switch 42. The switch 42 may be a typical on/off slide or push-button switch to stop the flow of current when the food treating apparatus is not in use. In the embodiment of FIG. 1, switch 42 is located on the battery holder 26. In the embodiment of FIG. 4, the switch 42 is located on the handle insert 22. It is contemplated that switch 42 may be located in any accessible location. Typically, the power source 28 will have a longer life if the switch 42 is turned off when the apparatus in not being used.

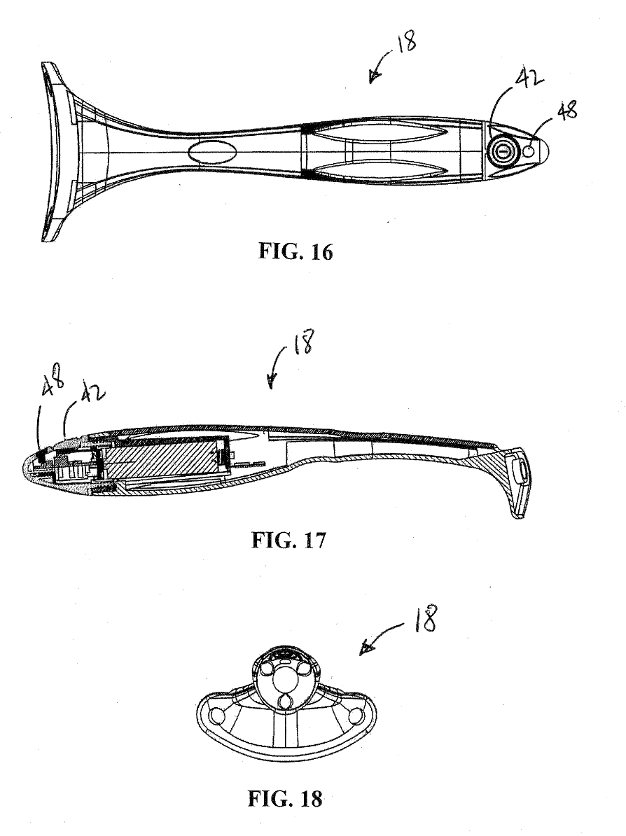

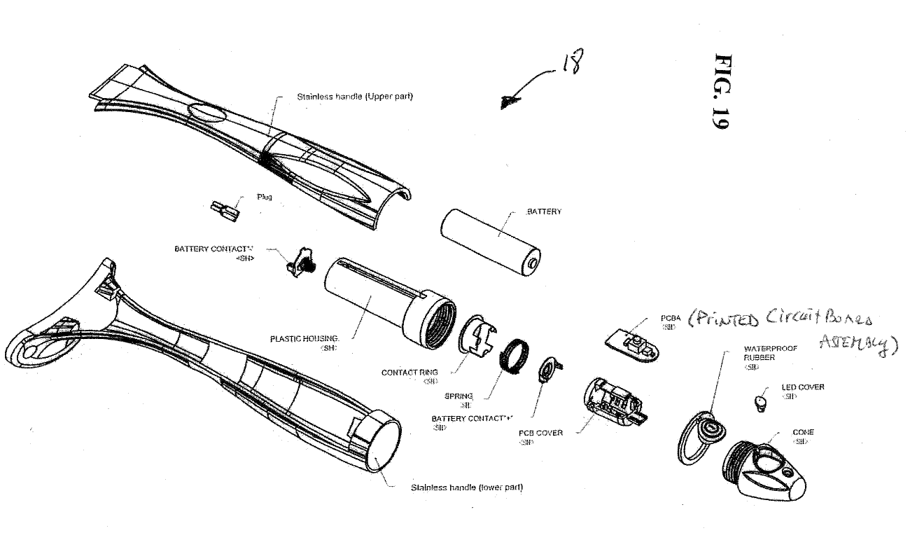

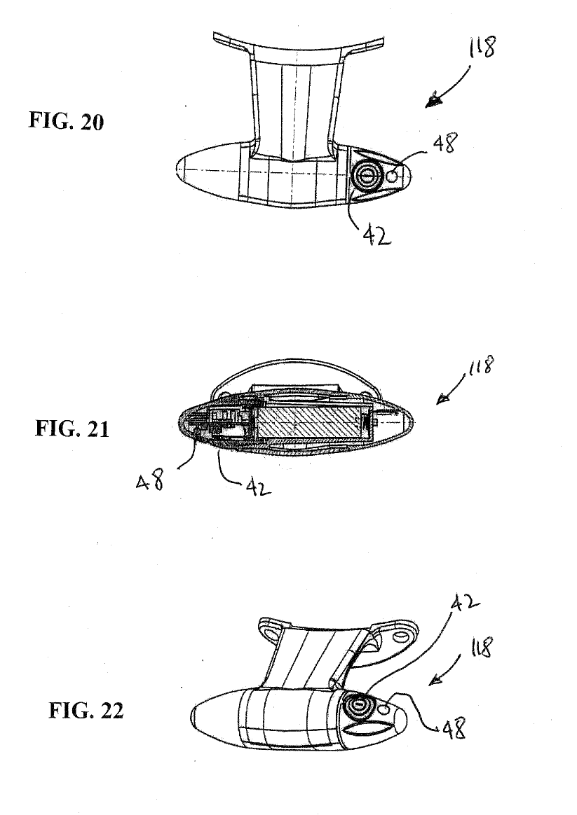

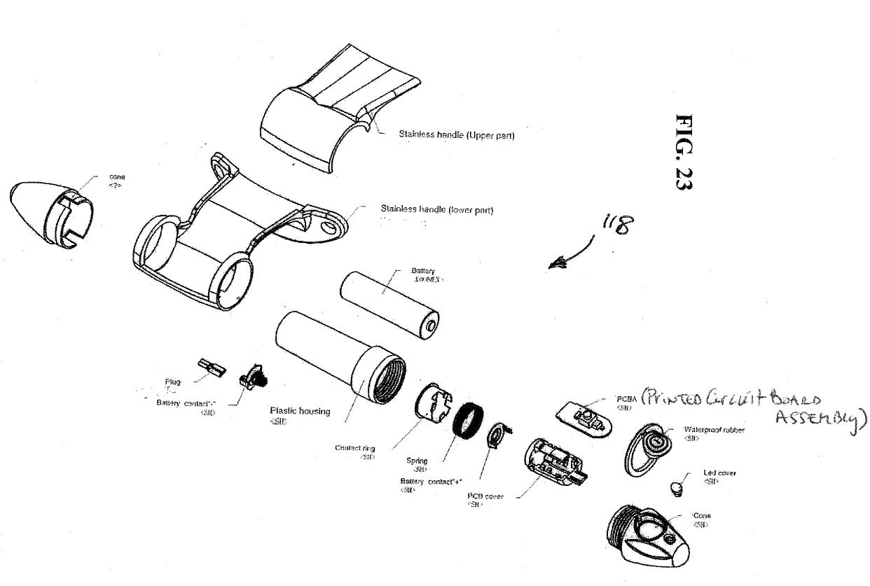

FIGS. 16-19 show an alternative embodiment of the long handle, such as the handle shown in FIG. 1. FIGS. 20-23 show an alternative embodiment of the short handle design, such as the handle shown in FIGS. 2 and 3. These alternative embodiments include an LED indicator and provide an alternative switch design and location. Further, a end-cap that includes the LED indicator and the switch attaches to the removable battery case via any commercially known means, including but not limited to screw means.

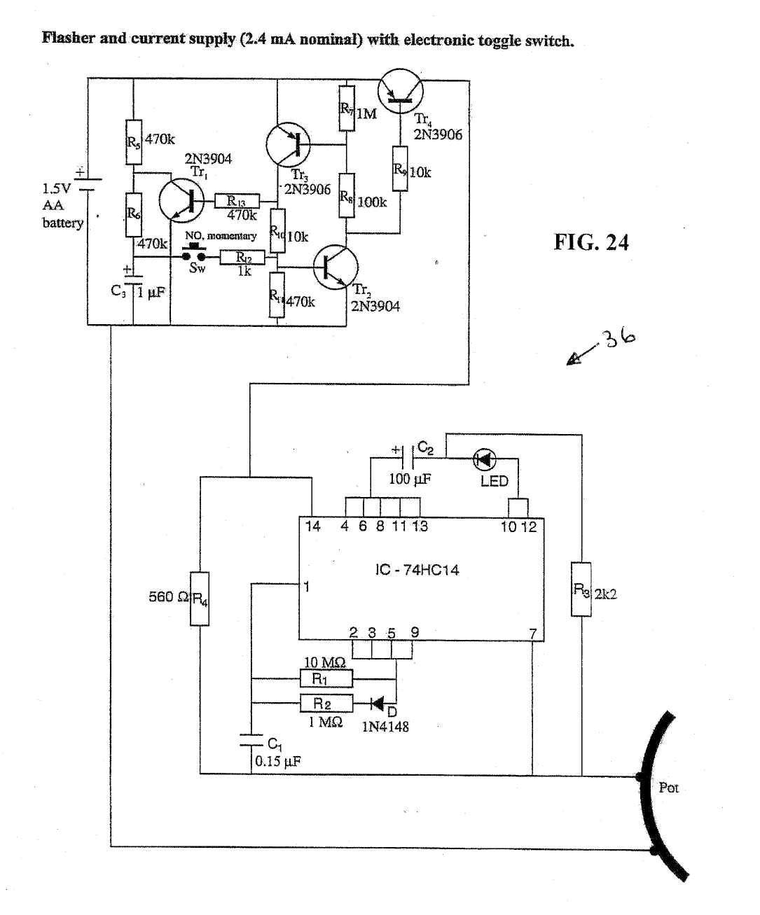

FIG. 24 represents an alternative embodiment of circuit 36. In the embodiment shown in FIG. 24, pressing Sw latches transistor Tr4 in conducting mode and the circuit turns on. Pressing Sw again turns off the current to the circuit. In this mode (off the circuit consumes virtually no power. The flasher itself operates by charging the capacitor C2 across the battery and then connecting it in series with the battery to supply approximately 3V (nominal) to the LED. Current limit to the LED is provided by the output of the gate. The flashing rate is approximately 1 per second by changes slightly with battery voltage. As the battery discharges, the flashing rate slows down because it takes longer to charge the capacitor.

In use, the food material 12 may absorb the electrons 38 where the food material 12 comes in contact with the food-contact surface 40. Alternatively or additionally, the electrons 38 may flow from the food-contact surface 40 through the medium 16 to the food material 12 to be absorbed by the food material. Excess electrons 38 are absorbed by the food material 12 to replace electrons lost by the thermally-induced oxidation of the cooking process, and may result in the food material 12 being electron enriched at the end of the cooking process, or at least in effect less electron depleted than would otherwise be the case. Although the absorption of electrons by the food material 12 is described in relationship to a cooking process, it would be understood by those skilled in the art that the invention may be used during cooling, storing, preparing or other food treating processes.

While this invention has been described with reference to embodiments thereof, it shall be understood that such description is by way of illustration and not by way of limitation. Therefore, the invention in its broader aspects is not limited to the specific details and illustrative examples shown and described herein. Accordingly, various modifications may be made without departing from the scope of the general inventive concept, defined by the terms of the appended claims.

What is claimed is:

1. A food treating apparatus comprising:
a conductive food-contacting surface;
a battery; and
an electric circuit for providing an electric current through the conductive food-contacting surface, wherein the electric circuit supplies an approximately constant current.

2. The food treating apparatus of claim 1, further comprising an indicator indicating that electric current is flowing through the electric circuit.

3. The food treating apparatus of claim 2, wherein the indicator indicates when the battery voltage reaches a threshold value.

4. A food treating apparatus comprising:
a vessel having a conductive food-contacting surface;
a handle adapted to house a removable battery holder and a battery; and
an electric circuit for providing an electric current through the conductive food-contacting surface, the electric circuit comprising:
at least two electrodes in electrical communication with the food-contacting surface; and
an indicator indicating that electric current is flowing through the electric circuit until the battery voltage reaches a threshold value, the indicator being an LED, wherein the electric circuit supplies an approximately constant current until the battery voltage reaches the threshold value;
wherein the constant current is between approximately 2.4 and 2.5 milliamperes, and the threshold value is 0.9 volts.

5. A method of providing electrons for absorption by an oxidizing medium comprising the steps of:
providing a conductive food-contacting surface;
placing the conductive food-contacting surface in contact with food; and
providing an approximately constant electric current from an electric circuit,
wherein the electric circuit includes a battery.
